(19) United States
(12) Patent Application Publication
(10) Pub. No.: US 2015/0271491 A1
(43) Pub. Date: Sep. 24, 2015

(54) ENHANCED INTRA PREDICTION MODE SELECTION FOR USE IN VIDEO TRANSCODING

(71) Applicant: ATI Technologies ULC, Markham (CA)

(72) Inventor: Jiao Wang, Richmond Hill (CA)

(73) Assignee: ATI Technologies ULC, Markham (CA)

(21) Appl. No.: 14/223,160

(22) Filed: Mar. 24, 2014

(51) Int. Cl. H04N 19/11; H04N 19/593; H04N 19/40

(52) U.S. Cl. CPC H04N 19/11; H04N 19/40; H04N 19/593

(57) ABSTRACT

An apparatus and a method for selecting an intra prediction mode for use in video transcoding obtain information from a decoder portion of a video transcoder regarding one or more intra prediction modes used in previously encoding one or more data blocks of a source image. The apparatus and method select an intra prediction mode for encoding a decoded data block corresponding to the one or more data blocks of the source image based on the information obtained from the decoder portion regarding the one or more intra prediction modes used in previously encoding the one or more data blocks of the source image.

### BACKGROUND OF THE DISCLOSURE

The disclosure relates generally to video transcoding and more particularly to motion compensation in re-encoding operations in video transcoding.

Video transcoding is used in numerous devices that have or support video playback capability to, for example, support universal multimedia access to video content. Example devices that implement or support video playback include, but are not limited to, home media servers, smart phones, tablets, other handheld computers, laptop computers, desktop computers, set-top boxes, content provider servers, etc. Video transcoding involves decoding a compressed image stream that has been encoded according to one standard, such as a standard used by a content provider, where the compressed image stream includes data for a series of image frames that collectively constitute video content. Decoding the compressed image stream produces decoded image data, and the transcoding process further involves encoding (or “re-encoding”) the decoded image data or image data corresponding thereto (e.g., a down-scaled or up-scaled version of the decoded image data) according to the same or a different standard. In either case, the standard according to which the decoded image data or image data corresponding thereto is encoded (or “re-encoded”) may be a standard that is supported by the device which is to implement or support the video playback.

As known in the art, homogeneous transcoding involves re-encoding decoded image data according to the same encoding standard used to previously generate the compressed image stream provided to the transcoder for decoding. For example, content originally encoded using the known H.264 standard, such as frames of image data on Blu-ray discs and frames of image data streamed from various Internet sources, may be re-encoded according to the H.264 standard during homogeneous transcoding but with less precision in order to accommodate limited decoding capability of a device that is to implement video playback of the frames of image data. Other example video encoding standards are known as well, such as the MPEG-2 standard commonly used in encoding, for example, various television signals and image data on Digital Versatile Discs (DVDs), and homogeneous transcoding may also be performed on content originally encoded using such other example standards.

Homogeneous transcoding, such as H.264-based homogeneous transcoding, may involve motion compensation that includes performing luma intra prediction on the macroblock level (e.g., on the level of 16×16 blocks of pixels in H.264) in an image frame. In luma intra prediction, the luma values for a macroblock are predicted using the luma values of nearby pixels in the same image frame. Various intra prediction modes are defined, each corresponding to a different way of using the luma values of the nearby pixels for luma intra prediction. A significant problem in luma intra prediction is the high computational load associated with selecting the intra prediction mode(s) to be used.

For example, a common approach to selecting the intra prediction mode(s) for a macroblock involves exhaustively calculating a rate distortion (RD) cost for each intra prediction mode supported for use with respect to the macroblock and then choosing the intra prediction mode(s) that yield the smallest RD cost. As known in the art, the RD cost of a particular intra prediction mode is essentially a measurement of the efficiency of that intra prediction mode, and reflects (i) the distortion between actual and predicted image data using a particular intra prediction mode versus (ii) the bit cost of encoding the predicted image data after applying the particular intra prediction mode.

In some encoding standards, a macroblock may be divided into smaller data blocks for intra prediction. For example, in H.264, three sizes of data blocks of pixels are defined for luma intra prediction: 4×4, 8×8, and the 16×16 macroblock. The exhaustive RD cost calculation for a macroblock may involve, for each smaller data block size that is available with respect to that macroblock: calculating the RD cost for each supported luma intra prediction mode for each data block of that size within the macroblock; identifying, for each data block of that size, the luma intra prediction mode with the smallest RD cost and further identifying what that smallest RD cost is; and adding up the smallest RD costs of each of the data blocks of that size within the macroblock to yield a smallest total RD cost for luma intra prediction of the macroblock when the macroblock is divided into data blocks of that size.

The exhaustive RD cost calculation for a macroblock may further involve calculating the RD cost for each luma intra prediction mode that is supported for luma intra prediction for the macroblock as a whole, identifying the luma intra prediction mode for the macroblock as a whole that has the smallest RD cost, and identifying that smallest RD cost. The transcoder may then compare the smallest RD cost corresponding to luma intra prediction for the macroblock as a whole to the smallest total RD cost(s) for luma intra prediction of the macroblock as divided into each smaller available data block size. Finally, the transcoder may identify the smallest of these RD costs, the associated data block size and mode(s), and perform luma intra prediction of the macroblock using the associated mode(s) and data block size as determined in the manner described above.

The computational load associated with such operations is extremely high. Depending upon considerations such as the fidelity requirements of the video playback environment, whether the video playback involves large video files and/or concurrent playback of multiple video files, and so on, this computational load may, for example, interfere with the ability to view the video content in real time (e.g., as the video content is transcoded) and/or may result in reduced-quality video playback. As user requirements and the capabilities supported by, for example, universal multimedia access and devices used for video playback continue to increase, the computational load associated with the above-described RD cost calculations will become increasingly unacceptable.

### BRIEF DESCRIPTION OF THE DRAWINGS

The embodiments will be more readily understood in view of the following description when accompanied by the below figures and wherein like reference numerals represent like elements, wherein:

FIG. 1 is a functional block diagram illustrating an apparatus that implements enhanced, computationally-efficient selection of an intra prediction mode for use in video transcoding, in accordance with an example set forth in the disclosure;

FIG. 2 is a functional block diagram of an enhanced intra prediction mode selection video transcoder, in accordance with another example set forth in the disclosure;

FIG. 3 illustrates a graphical representation of a set of potential intra prediction modes for a 4×4 data block, in accordance with an example set forth in the disclosure;

FIG. 4 illustrates a graphical representation of a set of pixels including a 4×4 data block of pixels for which luma values are to be predicted and the information needed to predict the luma values, in accordance with an example set forth in the disclosure;

FIG. 5 is a functional block diagram of an example of enhanced intra prediction mode selection encoder portion motion compensation logic of the enhanced intra prediction mode selection video transcoder, in accordance with another example set forth in the disclosure;

FIG. 6 is a flow chart illustrating an example method for selecting an intra prediction mode for use in video transcoding, in accordance with yet another example set forth in the disclosure;

FIG. 7 is a flow chart illustrating example aspects of a method for selecting an intra prediction mode for use in video transcoding, in accordance with another example set forth in the disclosure;

FIG. 8 is another flow chart illustrating example aspects of a method for selecting an intra prediction mode for use in video transcoding, in accordance with still another example set forth in the disclosure;

FIG. 9 is a functional block diagram of an example of decoder portion motion compensation and intra prediction mode providing logic of the enhanced intra prediction mode selection video transcoder, in accordance with yet another example set forth in the disclosure;

FIG. 10 is a flow chart illustrating an example method for providing information regarding one or more intra prediction modes used in previously encoding one or more data blocks of a source image, in accordance with another example set forth in the disclosure; and

FIG. 11 is a block diagram illustrating one example of an integrated circuit fabrication system.

### DETAILED DESCRIPTION OF THE PREFERRED EMBODIMENTS

Briefly, in one embodiment, an apparatus and a method for selecting an intra prediction mode for use in video transcoding reduce the computational load associated with selecting an intra prediction mode for a re-encoding portion of the video transcoding process. The apparatus may include logic that may perform actions as described below to reduce the computational load. The apparatus may be a device having video transcoding capability, such as a home media server, smart phone, tablet, other handheld computer, laptop computer, desktop computer, set-top box, content provider server, etc. Thus, the apparatus may include a video transcoder, which in turn includes the aforementioned logic that reduces the computational load. In some embodiments, the apparatus may also include a display and one or more processors that decode an output of the transcoder in order to provide output image data for display on the display.

The apparatus and method may obtain information from a decoder portion of a video transcoder regarding one or more intra prediction modes used in previously encoding one or more data blocks of a source image. For example, the obtained information may be information indicating, for each of one or more 4×4 data blocks of the source image (when intra 4×4 prediction is used in originally encoding the associated macroblock), an intra prediction mode used in originally encoding the data block in order to generate encoded source image data that is provided to the transcoder. The source image is, for example, an image frame included within video content that has, for example, been downloaded from the Internet at some previous time or that is, as another example, being streamed from the Internet. Depending upon the intra prediction modes used in previously encoding the one or more data blocks of the source image, the obtained information from the decoder portion may indicate one intra prediction mode (e.g., if the same intra prediction mode was used for each of the one or more data blocks or if the information is information regarding only one data block) or more than one intra prediction mode.

Based on the information obtained from the decoder portion, the apparatus and method may select an intra prediction mode for encoding a decoded data block corresponding to the one or more data blocks of the source image. For example, the decoder portion may generate decoded image data corresponding to the one or more data blocks of the source image, and an encoder portion of the video transcoder may obtain the decoded image data or a down-scaled or up-scaled version thereof in implementations where scaling is applied to the decoded image data. As such, the decoded data block for which an intra prediction mode is to be selected may be a data block within the decoded image data or a data block within a down-scaled or up-scaled version of the decoded image data. Thus, each decoded data block may correspond to one or more data blocks of the source image. For example, if a down-scaling factor of four is applied to the decoded image data, a single 4×4 decoded data block within the down-scaled version of the decoded image data will correspond to sixteen decoded data blocks (e.g., in an arrangement extending four data blocks horizontally by four data blocks vertically) within the decoded image data and thus to sixteen data blocks of the source image.

Among other advantages, the apparatus and method recognize that the intra prediction modes used in previously encoding one or more data blocks of a source image have a correlation with the intra prediction mode that is optimal for use in predicting a corresponding decoded data block for re-encoding. By selecting the intra prediction mode for encoding a decoded data block based on the information obtained from the decoder portion regarding the one or more intra prediction modes used in previously encoding the corresponding one or more data blocks of the source image, the exhaustive RD calculations can be avoided. Example techniques for advantageously selecting the intra prediction mode for encoding based on the obtained information, without performing the exhaustive RD calculations and still obtaining an efficient result (e.g., in terms of amount of distortion versus bit cost, as discussed above), are further discussed below.

For example, the apparatus and method may determine candidate intra prediction modes for encoding the decoded data block based on the information obtained from the decoder portion. More particularly, in one embodiment, when the one or more intra prediction modes used in previously encoding the one or more data blocks of the source image include a plurality of intra prediction modes that are available for encoding the decoded data block, the apparatus and method may determine an initial best candidate intra prediction mode for encoding the decoded data block. The apparatus and method may determine the initial best candidate intra prediction mode based on a plurality of differences between the decoded data block and predicted versions of the decoded data block. Each predicted version of the decoded data block may be a version of the decoded data block as predicted using one of the plurality of intra prediction modes used in previously encoding the one or more data blocks of the source image that are available for encoding the decoded data block.

The apparatus and method may also determine one or more additional candidate intra prediction modes based on the initial best candidate mode, such as intra prediction modes adjacent to the initial best candidate mode. This determination may reflect a recognition that one or more intra prediction modes adjacent to the initial best candidate mode may also be desirable intra prediction modes to consider for encoding the decoded data block, as such intra prediction modes may operate similarly to the initial best candidate mode (because of their proximity to the initial best candidate mode) and some image data may have been lost during the decoding process and, in some cases, during scaling operations (e.g., down-scaling or up-scaling of the decoded image data generated by the decoder portion).

The apparatus and method may evaluate the initial best candidate intra prediction mode and the one or more additional candidate intra prediction modes to select the intra prediction mode for encoding the decoded data block. For example, the apparatus and method may determine, for each respective one of the initial best candidate intra prediction mode and the one or more additional candidate intra prediction modes, a difference, such as a sum of absolute difference, between the decoded data block and the decoded data block as predicted using the respective intra prediction mode. The intra prediction mode for which the sum of absolute difference is smallest may be selected as the intra prediction mode for encoding the decoded data block.

Whether a particular intra prediction mode is available for encoding the decoded data block may depend upon a location of the decoded data block within its image frame. As one example, and as further discussed below, if the decoded data block is in the top row of its image frame, the apparatus and method may determine that certain intra prediction modes will not be available for encoding the decoded data block even if those modes were used in previously encoding the one or more data blocks of the source image.

In another embodiment, an apparatus includes image data analysis logic that may analyze image data corresponding to one or more data blocks of a source image to determine information regarding one or more intra prediction modes that were used in previously encoding the one or more data blocks of the source image. The image data analysis logic may provide the information regarding the one or more intra prediction modes that were used in previously encoding the one or more data blocks of the source image to an encoder portion of a video transcoder for use in efficiently selecting an intra prediction mode for re-encoding a decoded data block as discussed above.

Among other advantages, the apparatus and methods described herein may incorporate useful information from the decoder portion and, in some embodiments, expand the list of candidate modes in such a way that the modes evaluated are those more likely to have a low RD cost. By reducing the computational load needed to select an intra prediction mode for re-encoding a decoded data block, the apparatus and method benefit systems with limited processing power, allow for higher-quality video playback, particularly for large and/or multiple files being played back at once, and allow video playback devices having or utilizing transcoders having the features of the apparatus and method to be able to meet increasingly strict performance requirements. Other advantages, and other techniques for advantageously selecting the intra prediction mode for encoding a decoded data block in video transcoding based on the obtained information from the decoder portion, are further described herein and/or will be recognized by those of ordinary skill in the art based on the description herein.

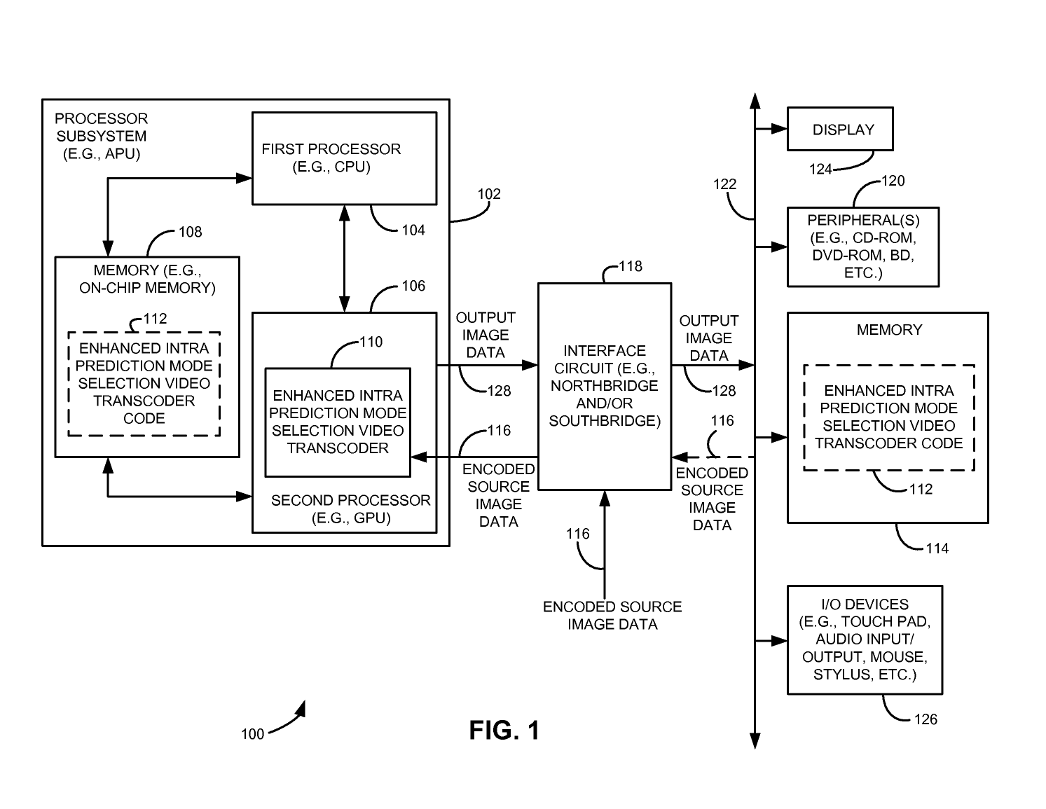

FIG. 1 is a functional block diagram illustrating an example apparatus 100 that implements enhanced, computationally-efficient selection of an intra prediction mode for use in video transcoding. In particular, the example apparatus 100 implements selection of an intra prediction mode for encoding a decoded data block corresponding to one or more data blocks of a source image based on information obtained from a decoder portion of a video transcoder regarding one or more intra prediction modes used in previously encoding the one or more data blocks of the source image. The source image may be, for example, one image frame of a series of image frames that collectively constitute video content.

In this example, the apparatus 100 is any suitable device supporting video transcoding and, in some cases, video playback capability, such as but not limited to a home media server, smart phone, tablet, other handheld computer, laptop or desktop computer, set-top box, content provider server, etc. For purposes of illustration only, the apparatus 100 will be described as a computing device having a processor subsystem 102, which includes a first processor 104 such as a central processing unit (CPU), a second processor 106 such as a graphics processing unit (GPU), and a memory 108, such as an on-chip memory.

If desired, the processor subsystem 102 may be an accelerated processing unit (APU), which as known in the art includes one or more CPU cores and one or more GPU cores on the same die. Such an APU may be, for example, an APU as sold by Advanced Micro Devices, Inc. (AMD) of Sunnyvale, Calif. Alternatively, one or more of the first and second processors 104 and 106 may perform general-purpose computing on GPU (GPGPU), may include one or more digital signal processors (DSPs), one or more application-specific integrated circuits (ASICs), or the first and second processors 104 and 106 may be any suitable processors.

The apparatus 100 includes an enhanced intra prediction mode selection video transcoder 110 that implements the enhanced intra prediction mode selection for the re-encoding performed during video transcoding. The enhanced intra prediction mode selection video transcoder 110 may be implemented as hardware, such as hardware implemented on the first processor 104 and/or the second processor 106. The enhanced intra prediction mode selection video transcoder 110 may also be implemented as discrete logic, a state machine, one or more programmable processors, and/or other suitable hardware.

The enhanced intra prediction mode selection video transcoder 110 may also be implemented as software executing on one or more processors such as the second processor 106 (e.g., a GPU) as shown in FIG. 1 and/or the first processor 104; or as one or more processors in combination with executable instructions executable by the one or more processors and stored on a computer readable storage medium where the executable instructions, when executed by the one or more processors, cause the one or more processors to perform the actions performed by the enhanced intra prediction mode selection video transcoder 110 as further described herein. For example, the executable instructions may be stored as enhanced intra prediction mode selection video transcoder code 112 in the memory 108 or, if desired, in an additional memory 114 (which may be a random access memory (RAM), a read only memory (ROM), or any suitable storage medium). The enhanced intra prediction mode selection video transcoder 110 may also be implemented in any other suitable manner such as but not limited to any suitable combination of the example implementations described above.

The enhanced intra prediction mode selection video transcoder 110 may receive, via an interface circuit 118, encoded source image data 116 corresponding to an encoding of the one or more data blocks of the source image. The enhanced intra prediction mode selection video transcoder 110 may also receive encoded source image data for the remaining data blocks of the source image so that, for example, the enhanced intra prediction mode selection video transcoder 110 receives encoded source image data for an entire image frame of a series of image frames, as discussed above. The enhanced intra prediction mode selection video transcoder 110 may then receive encoded source image data for a next subsequent image frame, and so on.

The encoded source image data 116 may be a compressed bitstream as known in the art and may be provided by any suitable image source. For example, the encoded source image data 116 may be streamed from any suitable server including any suitable Internet website, or may be received from a further additional memory such as a dynamic random access memory (DRAM) or ROM (not shown in FIG. 1) to which the encoded source image data 116 has been previously downloaded. For example, the encoded source image data 116 may have been previously downloaded in response to a user selection via a website to download particular video content. The interface circuit 118 may be or may include a northbridge and/or a southbridge, for example.

In some embodiments, as shown by the dashed communication link carrying the encoded source image data 116, the encoded source image data 116 may be received from one or more peripheral devices 120, which may be, for example, a Compact Disc Read-Only Memory (CD-ROM), a DVD Read-Only Memory (DVD-ROM), and/or a Blu-ray Disc (BD). In this example, the encoded source image data 116 is received from the one or more peripheral devices 120 via an expansion bus 122 of the apparatus 100. The expansion bus 122 may further connect to, for example, a display 124, the additional memory 114, and one or more input/output (I/O) devices 126 such as audio input/output devices, a mouse, a stylus, and/or any other suitable input/output device(s).

In any event, after performing the enhanced intra prediction mode selection for re-encoding as described herein, the enhanced intra prediction mode selection video transcoder 110 may encode (or “re-encode”) a decoded data block corresponding to one or more data blocks of the source image using the selected intra prediction mode and provide encoded output image data. The below-described enhanced intra prediction mode selection and re-encoding of a decoded data block corresponding to one or more data blocks of the source image may be repeated in order to provide encoded output image data for an entire image frame, and then for a next subsequent image frame and so on. For example, in the case of H.264-based homogeneous transcoding, a high definition (HD) H.264 compressed 1080p (1080 progressive lines of resolution) bitstream from a content provider may be decoded and then re-encoded into a standard definition (SD) H.264 compressed 480p bitstream for subsequent decoding and playback in a mobile phone which has relatively limited capability to decode a compressed bitstream in HD.

In the illustrated example, the second processor 106 (e.g., a GPU) decodes the encoded output image data to provide output image data 128 for display on the display 120, such as via the expansion bus 122. In other embodiments, the second processor 106 may not decode the encoded output image data, and the encoded output image data may, for example, be decoded by one or more other processors (e.g., the first processor 104 and/or an additional processor(s) not shown in FIG. 1), by other hardware and/or software executing on one or more processors, or in any other suitable manner, such as by a device located remotely from the apparatus 100.

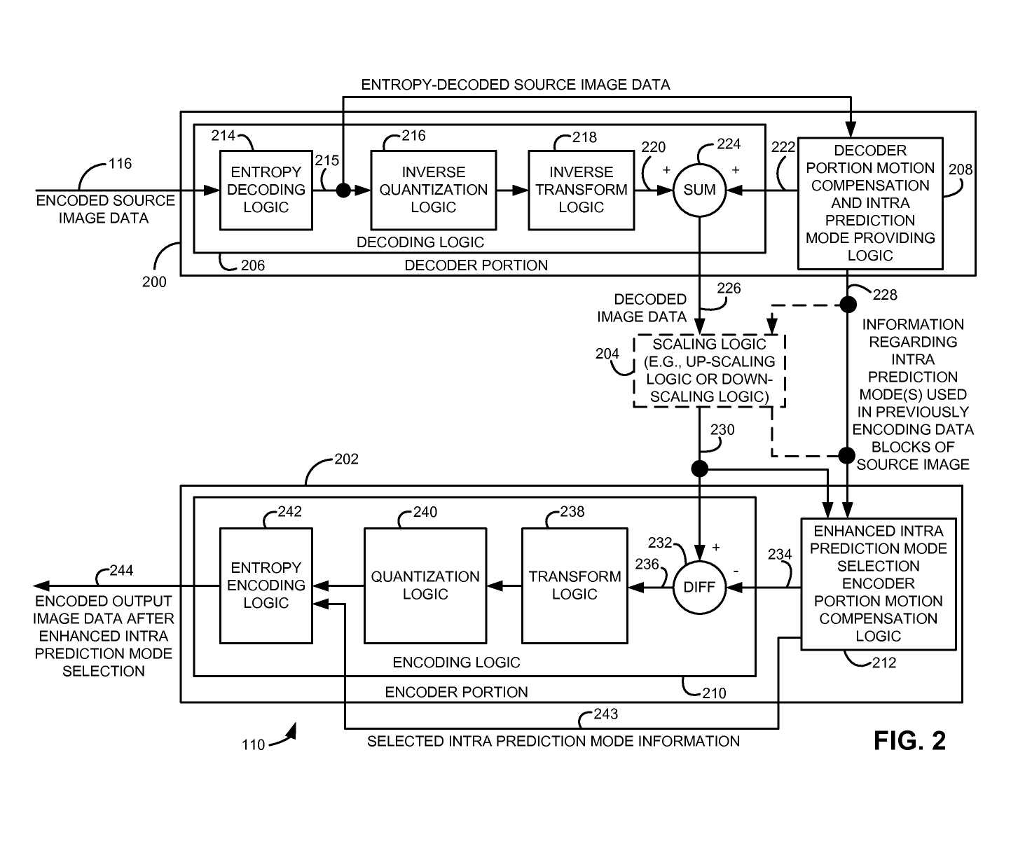

FIG. 2 is a functional block diagram of the enhanced intra prediction mode selection video transcoder 110, according to an example embodiment. The enhanced intra prediction mode selection video transcoder 110 may include a decoder portion 200, an encoder portion 202, and scaling logic 204. As discussed below, the scaling logic 204 may be implemented as up-scaling logic, as down-scaling logic, or if desired may be omitted. The decoder portion 200 includes decoding logic 206 and decoder portion motion compensation and intra prediction mode providing logic 208. The encoder portion 202 includes encoding logic 210 and enhanced intra prediction mode selection encoder portion motion compensation logic 212 that is used in implementing enhanced intra prediction mode selection so as to reduce the computational load in selecting an intra prediction mode for use in re-encoding, as further described below.

The various elements and logic, and one or both of the decoder portion 200 and the encoder portion 202, described herein may be implemented in any suitable manner. For example, logic and/or one or both of the decoder portion 200 and the encoder portion 202 may be implemented as hardware, such as hardware implemented on the first processor 104 and/or the second processor 106, as discrete logic, a state machine, one or more programmable processors, and/or other suitable hardware. Any of the described elements and logic, and/or one or both of the decoder portion 200 and the encoder portion 202, may also be implemented as software executing on one or more processors such as the second processor 106 and/or the first processor 104; or as one or more processors in combination with executable instructions executable by the one or more processors and stored on a computer readable storage medium. The various elements and logic, and one or both of the decoder portion 200 and the encoder portion 202, may also be implemented in any other suitable manner such as but not limited to any suitable combination of the example implementations described above, and may be implemented in whole or in part as physically distinct elements or may be understood as logical elements that are part of the same physical element.

The decoding logic 206 may receive the encoded source image data 116. The decoding logic 206 includes entropy decoding logic 214, which receives the encoded source image data 116 and outputs entropy-decoded source image data 215 to inverse quantization logic 216. The inverse quantization logic 216, in turn, provides its output to inverse transform logic 218, which in turn outputs an uncompressed residue 220.

As further described below, the decoder portion motion compensation and intra prediction mode providing logic 208 may also receive and process the entropy-decoded source image data 215 in order to determine the intra prediction mode(s) that was/were used in previously encoding the one or more data blocks of the source image (e.g., in originally encoding the one or more data blocks of the source image in order to generate the encoded source image data 116 or in otherwise encoding the one or more data blocks of the source image in order to generate the encoded source image data 116). The decoder portion motion compensation and intra prediction mode providing logic 208 may use the determined intra prediction mode(s) to determine a decoded image data prediction 222. The decoded image data prediction 222 may be summed with the uncompressed residue 220 by a summer 224 to generate decoded image data 226 that corresponds to the one or more data blocks of the source image. As noted above, encoded source image data may be received for an entire image frame, and for subsequent frames, and likewise the operation of the decoder portion 200 may generate decoded image data corresponding to a particular one or more blocks of the source image repeatedly so as to generate decoded image data for entire image frames.

The decoder portion motion compensation and intra prediction mode providing logic 208 may provide information 228 regarding the one or more intra prediction modes used in previously encoding the one or more data blocks of the source image to the enhanced intra prediction mode selection encoder portion motion compensation logic 212. For example, the information 228 may be or may include an indication of the intra prediction mode used in previously encoding each of the one or more data blocks of the source image. As shown in FIG. 2, the information 228 may be provided directly to the enhanced intra prediction mode selection encoder portion motion compensation logic 212, or if desired via the scaling logic 204 (though the scaling logic 204 may not perform any scaling operation on the information 228). The information 228 may also or alternatively be provided in any other suitable manner.

In one embodiment, the information 228 is information regarding one or more intra prediction modes used in previously encoding sixteen 4×4 data blocks (sixteen data blocks of four pixels by four pixels) of the source image (e.g., in an arrangement that extends the length of four data blocks horizontally and four data blocks vertically). In this embodiment, the decoded image data 226 corresponding to the sixteen blocks of the source image may be sixteen decoded data blocks at the same coordinate locations as the sixteen data blocks of the source image. In this embodiment, if the scaling logic 204 is implemented as down-scaling logic which down-scales the decoded image data 226 by a factor of four, a down-scaled version of the decoded image data 226 may be a single decoded data block. The down-scaled version of the decoded image data 226 may be provided to the encoder portion 202 via a communication link 230, which may be or may include a bus, a single line, a trace, a wireless link, or any suitable communication link.

In another example, the scaling logic 204 is implemented as up-scaling logic which up-scales the decoded image data 226 and provides an up-scaled version of the decoded image data 226 to the encoder portion 202 via the communication link 230. In the embodiment where the information 228 is information regarding one or more intra prediction modes used in previously encoding sixteen 4×4 data blocks of the source image, if the scaling logic 204 up-scales the decoded image data 226 by, for example, a factor of four, the up-scaled version of the decoded image data 226 may be two hundred fifty-six decoded data blocks (e.g., in an arrangement that extends the length of sixteen decoded data blocks horizontally and sixteen decoded data blocks vertically).

In yet another example, as discussed above, the scaling logic 204 may be omitted. In this example, the communication link 230 carries the decoded image data 226 (e.g., sixteen decoded data blocks, as discussed above) to the encoder portion 202.

Thus, the decoded image data 226, or the down-scaled or up-scaled version thereof, as input via the communication link 230 includes one or more decoded data blocks. Each of the one or more decoded data blocks is provided to a subtractor 232 and to the enhanced intra prediction mode selection encoder portion motion compensation logic 212. The enhanced intra prediction mode selection encoder portion motion compensation logic 212 determines a prediction 234 for each of the one or more decoded data blocks by selecting an intra prediction mode for encoding each decoded data block based on the information 228. For each decoded data block, the prediction 234 is provided to the subtractor 232, which determines a residue 236 between the decoded data block and the prediction 234 of the decoded data block. The subtractor 232 provides the residue 236 to transform logic 238, which in turn provides its output to quantization logic 240, which in turn provides its output to entropy encoding logic 242.

For each decoded data block, the enhanced intra prediction mode selection encoder portion motion compensation logic 212 may also provide selected intra prediction mode information 243 to the entropy encoding logic 242. The selected intra prediction mode information 243 may indicate the intra prediction mode selected for encoding the decoded data block or may be or may include any other suitable information from which the intra prediction mode selected for encoding the decoded data block may be determined during a subsequent process of decoding the output of the encoder portion 202. The entropy encoding logic 242 may receive the output of the quantization logic 240 and the selected intra prediction mode information 243 and may provide encoded output image data 244 after enhanced intra prediction mode selection. The above-described operations may be repeated for each decoded data block as necessary to perform intra prediction and re-encoding for an entire image frame (and subsequent image frames) of the same size as the image frame for the source image or for a down-scaled or up-scaled image frame, as the case may be. The encoded output image data 244 after enhanced intra prediction mode selection may be provided to any suitable device or devices for decoding and/or, for example, for suitable video playback after such decoding.

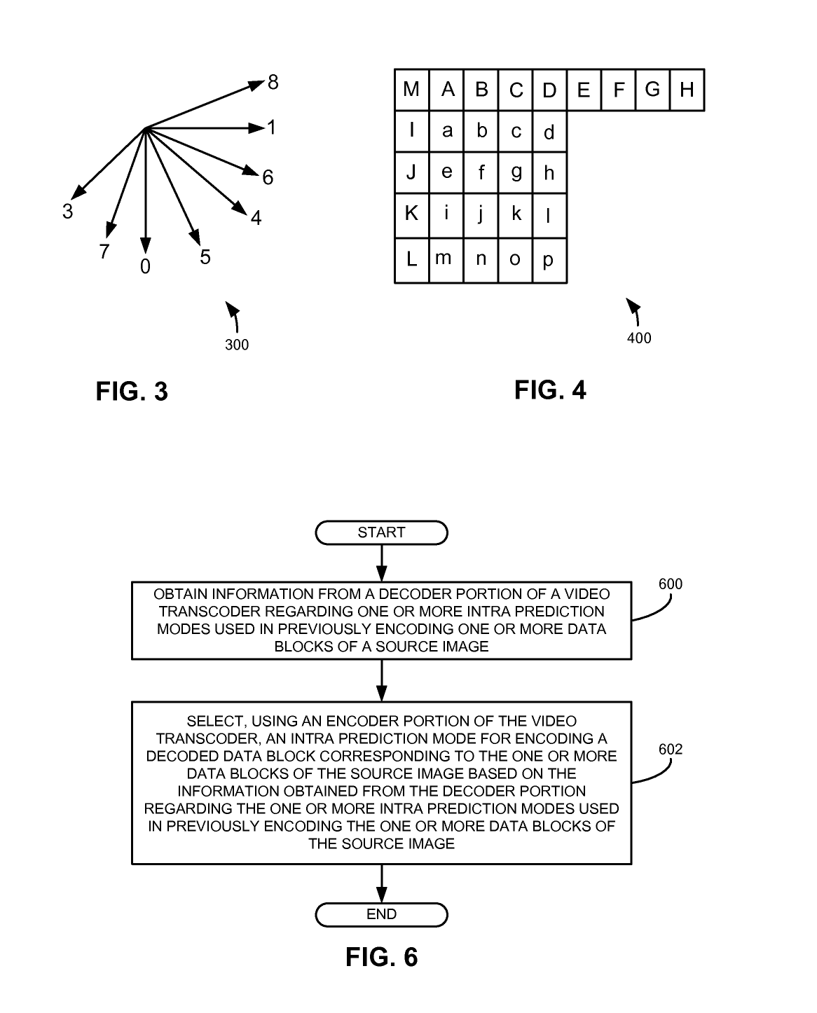

FIG. 3 illustrates a graphical representation of a set of potential intra prediction modes 300 for a 4×4 data block (e.g., four pixels by four pixels). For the example of H.264, as shown in FIG. 3, a 4×4 data block has nine potential luma intra prediction modes: mode 0 (vertical), mode 1 (horizontal), mode 2 (DC; not shown in FIG. 3 as explained below), mode 3 (diagonal down left), mode 4 (diagonal down right), mode 5 (vertical right), mode 6 (horizontal down), mode 7 (vertical left), and mode 8 (horizontal up).

FIG. 4 illustrates a graphical representation of a set of pixels 400 including a 4×4 data block of pixels for which luma values are to be predicted and the information needed to predict the luma values of the 4×4 data block of pixels. The 4×4 data block is designated by pixels “a” through “p,” and the luma values of a subset of neighboring pixels A-M are used to predict the luma values of the 4×4 data block including pixels “a” through “p” depending upon the selected intra prediction mode. For example, where mode 1 is selected as the intra prediction mode, the luma values of pixels “a”, “b”, “c”, and “d” are predicted by the luma value of neighboring pixel I. As known in the art, the prediction of the luma values of pixels “a” through “p” based on other intra prediction modes shown in FIG. 3 is similarly performed in a manner that takes the direction of the selected intra prediction mode into account. As further known in the art, mode 2 (DC), which is not shown in FIG. 3, takes the mean of the luma values of neighboring pixels A, B, C, D, I, J, K, and L as the prediction for the luma values of the current 4×4 data block of pixels “a” through “p.”

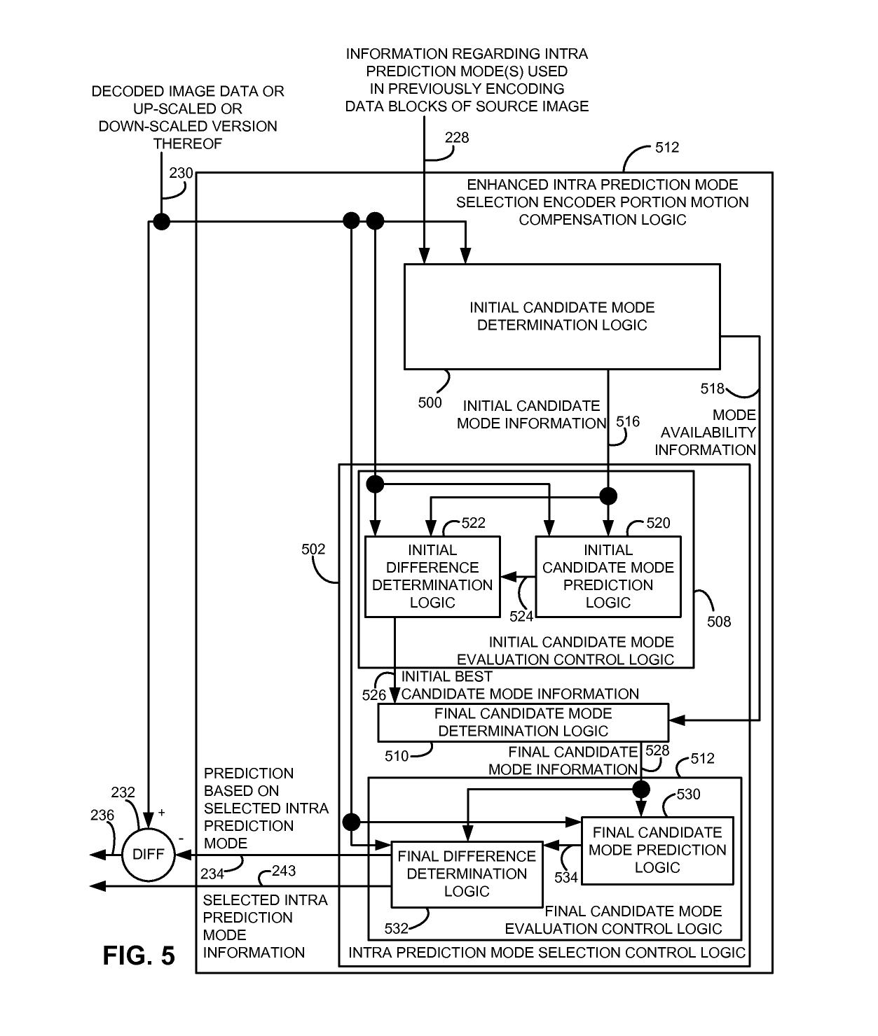

FIG. 5 is a functional block diagram of an example of the enhanced intra prediction mode selection encoder portion motion compensation logic 212. As shown in the example of FIG. 5, the enhanced intra prediction mode selection encoder portion motion compensation logic 212 includes initial candidate mode determination logic 500 and intra prediction mode selection control logic 502. The intra prediction mode selection control logic 502 includes initial candidate mode evaluation control logic 508, final candidate mode determination control logic 510, and final candidate mode evaluation control logic 512.

In one embodiment, the initial candidate mode determination logic 500 may receive the decoded image data 226 corresponding to the one or more data blocks of the source image, or the down-scaled or up-scaled version thereof, as input via the communication link 230. As noted above, the version of decoded image data input via the communication link 230 may include one or more decoded data blocks, and the initial candidate mode determination logic 500 may determine initial candidate mode information 516 (as further described below) for one decoded data block at a time. As each decoded data block input to the initial candidate mode determination logic 500 corresponds to one or more data blocks of the decoded image data 226 (e.g., is a decoded data block of the image data 226 or is a decoded data block of a down-scaled or up-scaled version thereof), each decoded data block input to the initial candidate mode determination logic 500 also corresponds to one or more data blocks of the source image. In this regard, it is noted that if the scaling logic 204 implements up-scaling, each decoded data block may correspond to one data block of the decoded image data 226. In particular, in an example where the scaling logic 204 implements up-scaling by a factor of four, each of sixteen decoded data blocks (e.g., in an arrangement extending horizontally four blocks and vertically four blocks) may correspond to a single data block of the decoded image data 226 that was up-scaled.

The initial candidate mode determination logic 500 may also receive the information 228 regarding the one or more intra prediction modes used in previously encoding the one or more data blocks of the source image. The initial candidate mode determination logic 500 may then determine the initial candidate mode information 516 indicating one or more initial candidate intra prediction modes for encoding each decoded data block. In one embodiment, the initial candidate mode determination logic 500 may determine the initial candidate mode information 516 so as to indicate that the initial candidate mode(s) for each decoded data block are one or more modes both: (i) used in previously encoding the corresponding one or more data blocks of the source image, as indicated by the information 228 obtained from the decoder portion 200, and (ii) available for intra prediction of the decoded data block based on a location of the decoded data block within its image frame, as further discussed below. In view of the foregoing disclosure, it will be understood that the image frame of the decoded data block may be an image frame including the decoded image data 226 if the scaling logic 204 is omitted, or may be a down-scaled or up-scaled version of the image frame including the decoded image data 226.

The initial candidate mode determination logic 500 may determine the initial candidate mode information 516 for each decoded data block in a sequential order, such as in a left-to-right, top-to-bottom fashion (e.g., starting with the upper left-most decoded data block and ending with the lower right-most decoded data block), and in this manner the initial candidate mode determination logic 500 may be aware of the location of each decoded data block within its image frame for purposes of determining availability of intra prediction modes. In this regard, the communication link 230 may, if desired, also carry information from the scaling logic 204 indicating, for example, the scaling factor used and/or other suitable information that informs the initial candidate mode determination logic 500 of the dimensions of the image frame within which the decoded data blocks are located. As further described below, the initial candidate mode determination logic 500 may also provide mode availability information 518 to the intra prediction mode selection control logic 502 indicating the determined availability of particular intra prediction modes for each decoded data block.

For example, if a decoded data block is in the top left corner of its image frame, only mode 2 (DC) is available for predicting the luma values of the pixels in the decoded data block. Thus, the initial candidate mode information 516 may indicate that the only candidate mode for such a decoded data block is mode 2. As another example, if the decoded data block is in the top row of its image frame, only the left side neighboring pixels can be used for intra prediction, so only mode 1 (horizontal) and mode 8 (horizontal up) are available for intra prediction. As yet another example, if the decoded data block is in the left column of its image frame, the left side neighboring pixels are not available for intra prediction, so only mode 0 (vertical), mode 3 (diagonal down left), and mode 7 (vertical left) are available for intra prediction. In each of the foregoing examples, the mode availability information 518 may also indicate the limited availability to the intra prediction mode selection control logic 502.

The initial candidate mode determination logic 500 may provide the initial candidate mode information 516 and the mode availability information 518 to the intra prediction mode selection control logic 502 for selection of an intra prediction mode to be used in encoding the decoded data block (e.g., for selection of a luma intra prediction mode to be used in encoding the luma component of the decoded data block). With continued reference to FIG. 5, reference is now also made to FIG. 6, which is a flow chart illustrating an example method for selecting an intra prediction mode for use in video transcoding.

As shown in block 600, the example method includes obtaining information from a decoder portion of a video transcoder regarding one or more intra prediction modes used in previously encoding one or more data blocks of a source image. For example, the initial candidate mode determination logic 500 may obtain the information 228 as discussed above.

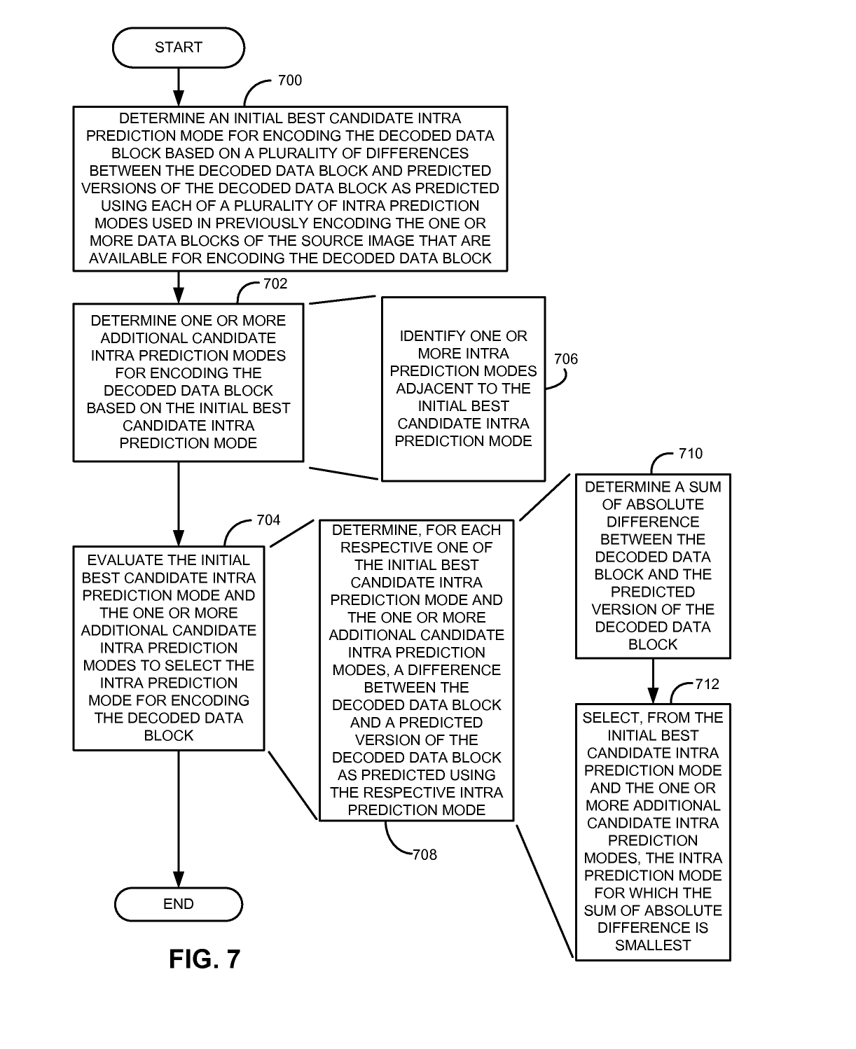

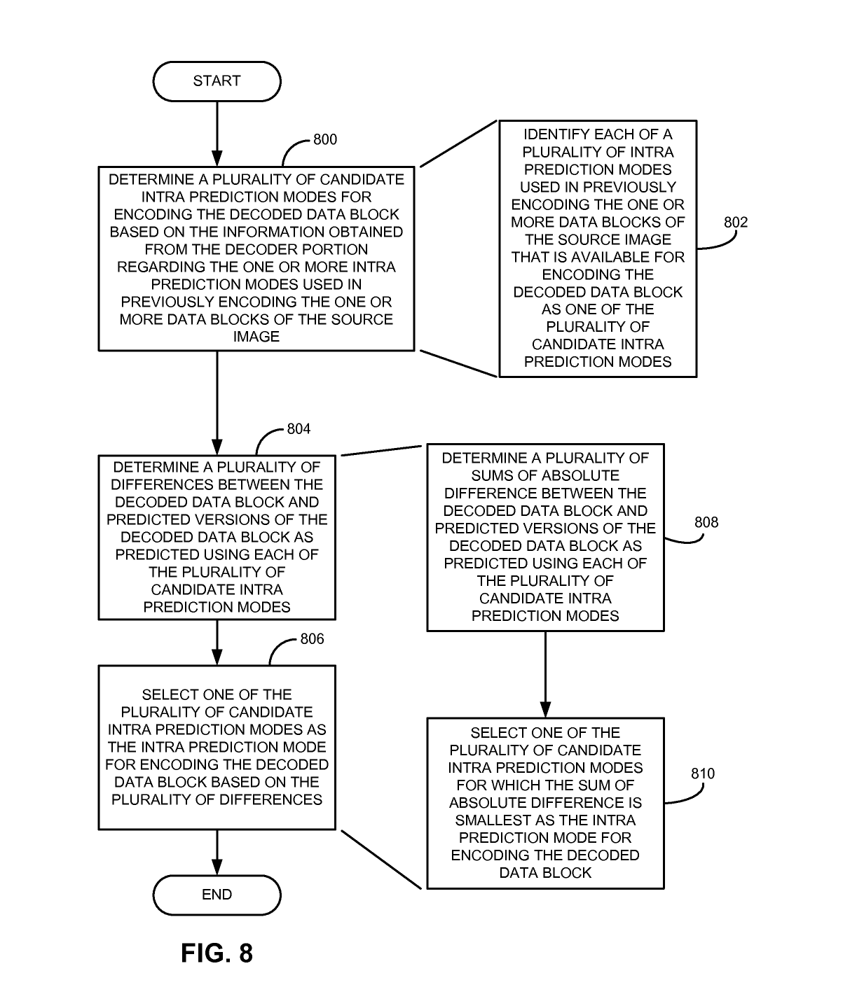

As shown in block 602, the method further includes selecting, using an encoder portion of the video transcoder, an intra prediction mode for encoding a decoded data block corresponding to the one or more data blocks of the source image based on the information 228 obtained from the decoder portion regarding the one or more intra prediction modes used in previously encoding the one or more data blocks of the source image. The block 602 will be further described with continued reference to FIG. 5 and with reference to FIGS. 7 and 8, which are flow charts illustrating example aspects of a method for selecting an intra prediction mode for use in video transcoding.

Referring to FIG. 7, as shown in block 700, the method may include determining an initial best candidate intra prediction mode for encoding the decoded data block based on a plurality of differences between the decoded data block and predicted versions of the decoded data block as predicted using each of a plurality of intra prediction modes used in previously encoding the one or more data blocks of the source image that are available for encoding the decoded data block. It will be appreciated that when the information 228 indicates that a plurality of intra prediction modes were used in previously encoding the one or more data blocks of the source image, the one or more data blocks of the source image are a plurality of data blocks of the source image. For example, the information 228 may include an indication of the intra prediction mode used in previously encoding each of the plurality of data blocks of the source image.

With continued reference to the block 700, in one embodiment, the initial candidate mode information 516 will be generated as discussed above and may indicate a plurality of intra prediction modes used in previously encoding the one or more data blocks of the source image that are available for encoding the decoded data block. The initial candidate mode information 516 may be provided to the initial candidate mode evaluation control logic 508, along with the decoded image data 226 or the down-scaled or up-scaled version thereof as input via the communication link 230. The initial candidate mode evaluation control logic 508 includes initial candidate mode prediction logic 520 and initial difference determination logic 522, such as sum of absolute difference (SAD) determination logic, to determine the aforementioned plurality of differences.

The initial candidate mode prediction logic 520 may generate a predicted version of the decoded data block for each one of the candidate intra prediction modes indicated by the initial candidate mode information 516. The initial candidate mode prediction logic 520 may then provide resulting predicted decoded data block information 524 to the initial difference determination logic 522. The initial difference determination logic 522 may determine the plurality of differences by subtracting the predicted decoded data block information 524 for each one of the candidate intra prediction modes from the content of (e.g., luma value of) the decoded data block as indicated by the data input via the communication link 230. In one embodiment, the initial difference determination logic 522 may perform these subtractions during SAD calculations for each one of the candidate intra prediction modes, as follows:

$$SAD ( m ) = {\sum }_{x , y} \vert Orig ( x , y ) - Pred ( x , y ) \vert$$

where Orig (x,y) is the original luma value at pixel position (x,y) (e.g., the luma value at pixel position (x,y) of the decoded data block without any prediction) and Pred(x,y) is the predicted luma value at pixel position (x,y) using the intra prediction mode m. Thus, SAD(m) may be the SAD between the luma values of the decoded data block and the luma values of the predicted version of the decoded data block as predicted using intra prediction mode m.

In one embodiment, the initial difference determination logic 522 determines the initial best candidate intra prediction mode as the mode for which the difference (e.g., SAD(m)) is smallest. The initial difference determination logic 522 then outputs initial best candidate mode information 526 indicating the initial best candidate intra prediction mode.

As shown in block 702, the method may further include determining one or more additional candidate intra prediction modes for encoding the decoded data block based on the initial best candidate intra prediction mode. As shown in block 704, the method may further include evaluating the initial best candidate intra prediction mode and the one or more additional candidate intra prediction modes to select the intra prediction mode for encoding the decoded data block.

Implementing the block 702 may include implementing block 706, as further shown in FIG. 7. As shown in block 706, determining the one or more additional candidate intra prediction modes may include identifying one or more intra prediction modes adjacent to the initial best candidate intra prediction mode. For example, the final candidate mode determination logic 510 may receive the initial best candidate mode information 526 and the mode availability information 518, and may determine based on this received information whether the two intra prediction modes immediately adjacent to the initial best candidate intra prediction mode are available for use in encoding the decoded data block. For example, with reference to FIG. 3, if the initial best candidate intra prediction mode is mode 0, and the mode availability information indicates that both mode 7 (immediately adjacent to mode 0 on the left) and mode 5 (immediately adjacent to mode 0 on the right) are available for use in encoding the decoded data block, the final candidate mode determination logic 510 may generate final candidate mode information 528 indicating that the final candidate modes to be considered are mode 0 (the initial best candidate intra prediction mode), mode 7 (a first additional candidate intra prediction mode), and mode 5 (a second additional candidate intra prediction mode).

The selection of intra prediction modes adjacent to the initial best candidate intra prediction mode may reflect a recognition that because of the decoding process and, in some cases, scaling operations, some image data is lost and the effort to determine an efficient (e.g., in terms of distortion versus bit cost) intra prediction mode may be enhanced by considering modes adjacent to the initial best candidate intra prediction mode. Considering several adjacent modes (e.g., the two immediately adjacent modes when available) may, in many applications, still maintain the required speed in re-encoding for real-time video playback and/or for playback in systems with limited processing power, and may still maintain a significant reduction in the computational load associated with selecting the intra prediction mode for re-encoding.

In other embodiments, the one or more additional candidate modes may be determined based on any other suitable criteria, such as determining up to two (or more, if desired) additional candidate modes nearest the initial best candidate intra prediction mode if one or more of the immediately adjacent modes is unavailable for use in re-encoding the decoded data block. In still other embodiments, no additional candidate modes may be determined and the actions performed by the block 702 (and the block 706, in some embodiments) may be omitted. In such embodiments, the final candidate mode determination logic 510 may also be omitted.

Referring back to the block 704, implementing the block 704 may include implementing block 708. As shown in block 708, evaluating the initial best candidate intra prediction mode and the one or more additional candidate intra prediction modes to select the intra prediction mode for encoding the decoded data block may include determining, for each respective one of the initial best candidate intra prediction mode and the one or more additional candidate intra prediction modes, a difference between the decoded data block and a predicted version of the decoded data block as predicted using the respective intra prediction mode.

With reference to FIG. 5, in one embodiment, the final candidate mode evaluation control logic 512 includes final candidate mode prediction logic 530 and final difference determination logic 532. The final candidate mode prediction logic 530 may receive the decoded image data 226 or the down-scaled or up-scaled version thereof and the final candidate mode information 528. Using this received information, the final candidate mode prediction logic 530 may generate a predicted version of the decoded data block for each one of the final candidate intra prediction modes indicated by the final candidate mode information 528. The final candidate mode prediction logic 530 may then provide resulting final predicted decoded data block information 534 to the final difference determination logic 532. The final difference determination logic 532 may determine the plurality of differences by subtracting the final predicted decoded data block information 534 for each one of the final candidate intra prediction modes from the content of the decoded data block.

In one embodiment, the final difference determination logic 532 may perform these subtractions using the same SAD equation as discussed above with respect to the block 700 and the initial difference determination logic 522. Thus, as further shown in FIG. 7, implementing the block 708 may include implementing blocks 710 and 712, and as shown in block 710, determining, for each respective one of the initial best candidate intra prediction mode and the one or more additional candidate intra prediction modes, a difference between the decoded data block and a predicted version of the decoded data block as predicted using the respective intra prediction mode may include determining a sum of absolute difference between the decoded data block and the predicted version of the decoded data block. As shown in block 712, the method may further include selecting, from the initial best candidate intra prediction mode and the one or more additional candidate intra prediction modes, the intra prediction mode for which the sum of absolute difference is smallest.

Referring back to FIG. 5, the final difference determination logic 532 may output the prediction 234 of the decoded data block based on the selected intra prediction mode. As discussed above, the prediction 234 may be provided to the subtractor 232 and ultimately result in the encoded output image data 244 being provided by the enhanced intra prediction mode selection video transcoder 110. Additionally, with reference to the discussion of FIG. 2, the final difference determination logic 532 may provide the selected intra prediction mode information 243 to the entropy encoding logic 242. The selected intra prediction mode information 243 may, in one embodiment, indicate the intra prediction mode selected for encoding the decoded data block.

As discussed above, in some embodiments, no additional candidate modes may be determined and the actions performed by the block 704 (and the blocks 708, 710, and 712) may be omitted. In such embodiments, the final candidate mode evaluation control logic 512 may also be omitted and the intra prediction mode indicated by the initial best candidate mode information 526 may be used to predict the decoded data block and provide the resulting prediction 234 to the subtractor 232. Omitting some or all of the blocks 702-712 may be desirable when maximum transcoding speed is to be realized, such as in systems with particularly limited processing power, when implementing particularly processor-intensive video transcoding, etc.

As discussed above, FIG. 8 is another flow chart illustrating example aspects of a method for selecting an intra prediction mode for use in video transcoding. As shown in block 800, the method may include determining a plurality of candidate intra prediction modes for encoding the decoded data block based on the information 228 obtained from the decoder portion regarding the one or more intra prediction modes used in previously encoding the one or more data blocks of the source image. As shown in FIG. 8, implementing the block 800 may include implementing block 802, which shows that determining the plurality of candidate intra prediction modes for encoding the decoded data block based on the information obtained from the decoder portion may include identifying each of a plurality of intra prediction modes used in previously encoding the one or more data blocks of the source image that is available for encoding the decoded data block as one of the plurality of candidate intra prediction modes. Thus, as discussed above, the initial candidate mode determination logic 500, for example, may determine which of the intra prediction modes used in previously encoding the one or more data blocks of the source image is available for encoding the decoded data block.

With continued reference to the block 800, in some embodiments, the initial candidate mode determination logic 500 may determine that the initial candidate modes are to include each intra prediction mode used in previously encoding the one or more data blocks of the source image that is available for encoding the decoded data block and one or more additional intra prediction modes, such as but not limited to intra prediction modes adjacent to each available intra prediction mode used in previously encoding the one or more data blocks of the source image. Such a determination may reflect a recognition that because of decoding operations and, in some cases, scaling operations, some data regarding the source image has been lost, so intra prediction modes near (e.g., adjacent to) those used in previously encoding the one or more data blocks of the source image may be desirable candidates to consider for re-encoding. The initial candidate mode information 516 is, in this embodiment, then provided accordingly so as to reflect the one or more additional intra prediction modes. The determination of the initial candidate mode information 516 may be made in other suitable ways as well.

As shown in block 804, the method may further include determining a plurality of differences between the decoded data block and predicted versions of the decoded data block as predicted using each of the plurality of candidate intra prediction modes. As shown in block 806, the method may further include selecting one of the plurality of candidate intra prediction modes as the intra prediction mode for encoding the decoded data block based on the plurality of differences. As further shown in FIG. 8, implementing the blocks 804 and 806 may include implementing blocks 808 and 810. As shown in block 808, the method may include determining a plurality of sums of absolute difference between the decoded data block and predicted versions of the decoded data block as predicted using each of the plurality of candidate intra prediction modes (e.g., a plurality of sums of absolute difference between the luma values of the decoded data block and the luma values of the predicted versions of the decoded data block). As shown in block 810, the method may include selecting one of the plurality of candidate intra prediction modes for which the sum of absolute difference is smallest as the intra prediction mode for encoding the decoded data block.

Thus, with reference to FIG. 5, the initial candidate mode prediction logic 520 may receive the decoded image data 226 or the down-scaled or up-scaled version thereof and may receive the initial candidate mode information 516, where the initial candidate mode information 516 may, as discussed with respect to the block 800, indicate candidate modes not used in previously encoding the one or more data blocks of the source image. The initial candidate mode prediction logic 520 may then generate a predicted version of the decoded data block for each intra prediction mode indicated by the initial candidate mode information 516 in a similar manner as discussed above. Additionally, the initial difference determination logic 522 may determine a plurality of differences in a similar manner as discussed above for each intra prediction mode indicated by the initial candidate mode information 516 where, again, the intra prediction modes indicated by the initial candidate mode information 516 may include one or more intra prediction modes not used in previously encoding the one or more data blocks of the source image. As a result, in some situations, the initial best candidate intra prediction mode information 526 may indicate that the initial best candidate intra prediction mode is a mode that was not used in previously encoding the one or more data blocks of the source image. In such a situation, the remainder of the determinations by the enhanced intra prediction mode selection encoder portion motion compensation logic 212, as shown in FIG. 5 and further described with reference to, for example, FIG. 7, may proceed accordingly.

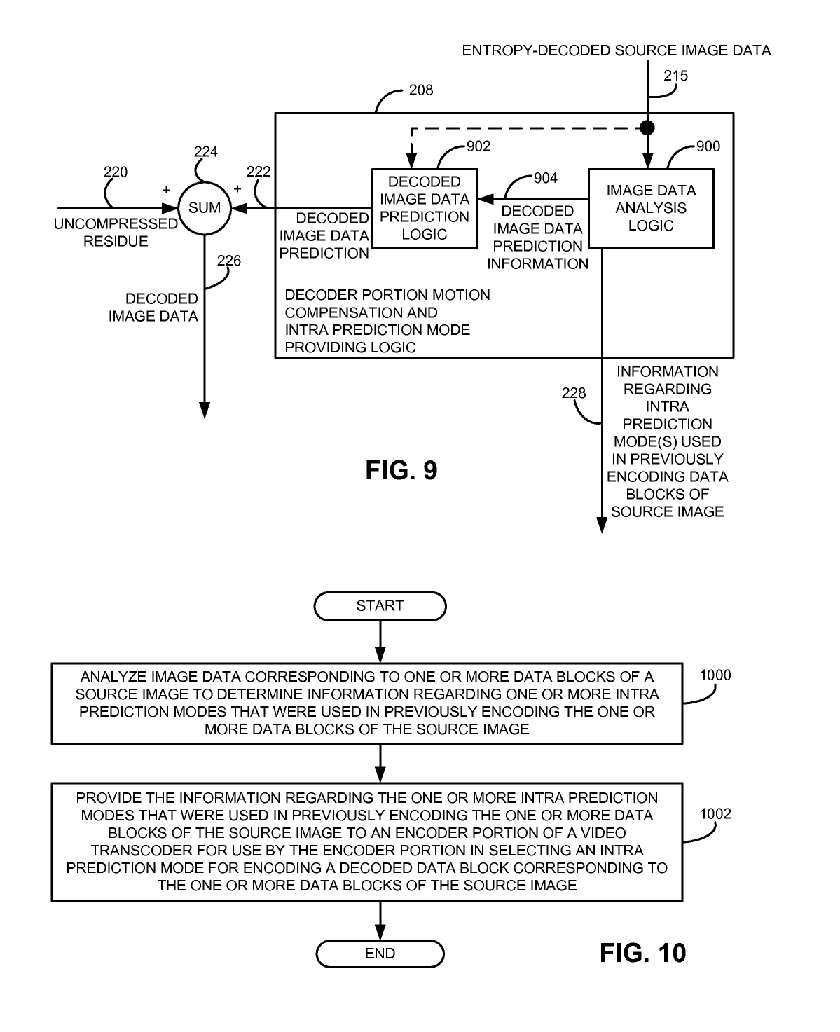

FIG. 9 is a functional block diagram of an example of the decoder portion motion compensation and intra prediction mode providing logic 208. As shown in the example of FIG. 9, the decoder portion motion compensation and intra prediction mode providing logic 208 may include image data analysis logic 900 and decoded image data prediction logic 902. With continued reference to FIG. 9, reference is now also made to FIG. 10, which is a flow chart illustrating an example method for providing information regarding one or more intra prediction modes used in previously encoding one or more data blocks of a source image.

As shown in block 1000, the example method includes analyzing image data corresponding to one or more data blocks of a source image to determine information regarding one or more intra prediction modes that were used in previously encoding the one or more data blocks of the source image. For example, and with reference to FIG. 2, the image data analysis logic 900 may receive the entropy-decoded source image data 215 after the entropy decoding of the encoded source image data 116. In another embodiment, the image data analysis logic 900 may receive the encoded source image data 116 (not shown as such in FIG. 2 or FIG. 9). In any event, the image data analysis logic 900 may perform any suitable analysis on the image data corresponding to the one or more data blocks of the source image. For example, the image data analysis logic 900 may parse at least a portion of the entropy-decoded source image data 215, such as parsing one or more headers of one or more data packets (e.g., H.264 data packets) of the entropy-decoded source image data 215, to determine the information regarding the one or more intra prediction modes that were used in previously encoding the one or more data blocks of the source image.

As shown in block 1002, the method further includes providing the information regarding the one or more intra prediction modes that were used in previously encoding the one or more data blocks of the source image to an encoder portion of a video transcoder for use by the encoder portion in selecting an intra prediction mode for encoding a decoded data block corresponding to the one or more data blocks of the source image. For example, as shown in FIG. 9, the image data analysis logic 900 may provide the information determined as described with respect to block 1000 as the information 228 regarding the one or more intra prediction modes used in previously encoding the one or more data blocks of the source image. As further shown in FIG. 2 and as discussed above, the information 228 may be provided to the enhanced intra prediction mode selection encoder portion motion compensation logic 212 for use by the enhanced intra prediction mode selection encoder portion motion compensation logic 212 in selecting an intra prediction mode for encoding a decoded data block corresponding to the one or more data blocks of the source image.

With continued reference to FIG. 9, the image data analysis logic 900 may determine decoded image data prediction information 904 based on its analysis of, for example, the entropy-decoded source image data 215. In some embodiments, the decoded image data prediction information 904 may be or may include the information 228 regarding the one or more intra prediction modes used in previously encoding the one or more data blocks of the source image. The decoded image data prediction information 904 may be provided from the image data analysis logic 900 to the decoded image data prediction logic 902. The decoded image data prediction logic 902 may use the decoded image data prediction information 904 to determine the decoded image data prediction 222, which as noted above may be summed with the uncompressed (e.g., decoded) residue 220 by the summer 224 to generate the decoded image data 226. As further shown in FIG. 9, if desired, the entropy-decoded source image data 215 may also be input to the decoded image data prediction logic 902 for use by the decoded image data prediction logic 902 in determining the decoded image data prediction 222. In another example, if desired, the encoded source image data 116 or any other suitable information (not shown) may be input to the decoded image data prediction logic 902 for use in determining the decoded image data prediction 222.

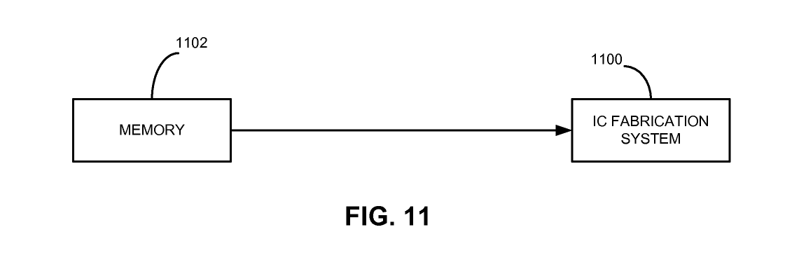

Referring to FIG. 11, an integrated circuit fabrication system 1100 is shown which may include access to memory 1102 which may be in any suitable form and any suitable location accessible via the web, accessible via hard drive or any other suitable way. The memory 1102 is a non-transitory computer readable medium such as but not limited to RAM, ROM, and any other suitable memory. The IC fabrication system 1100 may be one or more work stations that control a wafer fabrication to build integrated circuits. The memory 1102 may include thereon instructions that when executed by one or more processors causes the integrated circuit fabrication system 1100 to fabricate one or more integrated circuits that include the logic and structure described herein.

The disclosed integrated circuit designs may be employed in any suitable apparatus including but not limited to, for example, home media servers; smart phones; tablets; other handheld computers; laptop computers; desktop computers; set-top boxes; content provider servers; or any other suitable device(s). Such devices may include, for example, an image source that provides encoded source image data to the one or more integrated circuits, and/or a display to display decoded output image data, etc., where the one or more integrated circuits may be or may include, for example, an APU, GPU, CPU or any other suitable integrated circuit(s) that implement the enhanced intra prediction mode selection video transcoder or portion(s) thereof as described herein. Such an apparatus may employ the one or more integrated circuits as noted above including the initial candidate mode determination logic, the intra prediction mode selection control logic, and other components described above.

Also, integrated circuit design systems (e.g., work stations including, as known in the art, one or more processors, associated memory in communication via one or more buses or other suitable interconnect and other known peripherals) are known that create wafers with integrated circuits based on executable instructions stored on a computer readable medium such as but not limited to CDROM, RAM, other forms of ROM, hard drives, distributed memory, etc. The instructions may be represented by any suitable language such as but not limited to hardware descriptor language (HDL), Verilog or other suitable language. As such, the logic and structure described herein may also be produced as one or more integrated circuits by such systems using the computer readable medium with instructions stored therein. For example, one or more integrated circuits with the aforedescribed logic and structure may be created using such integrated circuit fabrication systems. In such a system, the computer readable medium stores instructions executable by one or more integrated circuit design systems that causes the one or more integrated circuit design systems to produce one or more integrated circuits. The one or more integrated circuits include, for example, initial candidate mode determination logic and intra prediction mode selection control logic that implement enhanced intra prediction mode selection for re-encoding in video transcoding, as described above, and may also include, for example, image data analysis logic and other aspects of the enhanced intra prediction mode selection video transcoder described herein.

Among other advantages, the disclosed embodiments recognize that the intra prediction modes used in previously encoding one or more data blocks of a source image have a correlation with the intra prediction mode that is optimal for use in predicting and encoding a decoded data block that corresponds to the one or more data blocks of the source image. The disclosed embodiments thus advantageously select an intra prediction mode for encoding the decoded data block based on information obtained from the decoder portion regarding one or more intra prediction modes used in previously encoding the corresponding one or more data blocks of the source image. The disclosed embodiments further advantageously perform determinations to evaluate candidate modes so as to select an intra prediction mode that is efficient in terms of distortion versus bit cost but without performing exhaustive and computationally intensive RD calculations. As a result, transcoding time and playback quality may be improved, particularly for systems with limited processing power, for large and/or multiple files being played back at once, etc.

As known in the art, in H.264-based luma intra prediction, nine potential luma intra prediction modes exist for a 4×4 block of pixels, which has been the pixel block size referenced in many examples set forth in this disclosure. However, it will be appreciated by one of ordinary skill in the art that the principles set forth herein may also be applied to other block sizes and/or other encoding standards. For example, the principles set forth herein may be applied to an 8×8 block of pixels which, as known in the art, also has nine potential luma intra prediction modes in H.264-based luma intra prediction. The features disclosed herein may also be applied to a 16×16 macroblock in, for example, H.264, which as known in the art has four potential luma intra prediction modes.

Moreover, while the various functional block diagrams and flow charts shown and described herein have been shown and described with particular configurations and with the blocks of the flow charts in a particular order, it will be appreciated that suitable variations may be made. For example, one or more blocks of a flow chart may be omitted if desired, may be performed during the same or overlapping periods of time, may be performed in a different suitable order, etc. Moreover, for example, it will be recognized by one of ordinary skill in the art that actions illustrated in FIG. 7, and/or actions illustrated in FIG. 8, may be used to implement aspects of the method shown in FIG. 6. Other suitable variations will be recognized by one of ordinary skill in the art.

The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

What is claimed is:

1. A method for selecting an intra prediction mode for use in video transcoding, comprising:
obtaining information from a decoder portion of a video transcoder regarding one or more intra prediction modes used in previously encoding one or more data blocks of a source image; and
selecting, using an encoder portion of the video transcoder, an intra prediction mode for encoding a decoded data block corresponding to the one or more data blocks of the source image based on the information obtained from the decoder portion regarding the one or more intra prediction modes used in previously encoding the one or more data blocks of the source image.

2. The method of claim 1, wherein the one or more intra prediction modes used in previously encoding the one or more data blocks of the source image comprise a plurality of intra prediction modes that are available for encoding the decoded data block, and wherein selecting the intra prediction mode for encoding the decoded data block comprises:
determining an initial best candidate intra prediction mode for encoding the decoded data block based on a plurality of differences between the decoded data block and predicted versions of the decoded data block as predicted using each of the plurality of intra prediction modes;
determining one or more additional candidate intra prediction modes for encoding the decoded data block based on the initial best candidate intra prediction mode; and
evaluating the initial best candidate intra prediction mode and the one or more additional candidate intra prediction modes to select the intra prediction mode for encoding the decoded data block.

3. The method of claim 2, wherein determining the one or more additional candidate intra prediction modes comprises identifying one or more intra prediction modes adjacent to the initial best candidate intra prediction mode, and wherein evaluating the initial best candidate intra prediction mode and the one or more additional candidate intra prediction modes comprises determining, for each respective one of the initial best candidate intra prediction mode and the one or more additional candidate intra prediction modes, a difference between the decoded data block and a predicted version of the decoded data block as predicted using the respective intra prediction mode.

4. The method of claim 3, wherein determining, for each respective one of the initial best candidate intra prediction mode and the one or more additional candidate intra prediction modes, the difference between the decoded data block and the predicted version of the decoded data block comprises determining a sum of absolute difference between the decoded data block and the predicted version of the decoded data block, and wherein selecting the intra prediction mode for encoding the decoded data block comprises selecting, from the initial best candidate intra prediction mode and the one or more additional candidate intra prediction modes, the intra prediction mode for which the sum of absolute difference is smallest.

5. The method of claim 1, wherein the one or more intra prediction modes used in previously encoding the one or more data blocks of the source image comprise a plurality of intra prediction modes, and wherein the method comprises:
determining whether each of the plurality of intra prediction modes is available for encoding the decoded data block based on a location of the decoded data block within a decoded image corresponding to the source image; and
evaluating each of the plurality of intra prediction modes that is determined to be available for encoding the decoded data block to select the intra prediction mode for encoding the decoded data block.

6. The method of claim 1, comprising determining a plurality of candidate intra prediction modes for encoding the decoded data block based on the information obtained from the decoder portion regarding the one or more intra prediction modes used in previously encoding the one or more data blocks of the source image,
wherein selecting the intra prediction mode for encoding the decoded data block comprises:
determining a plurality of differences between the decoded data block and predicted versions of the decoded data block as predicted using each of the plurality of candidate intra prediction modes; and
selecting one of the plurality of candidate intra prediction modes as the intra prediction mode for encoding the decoded data block based on the plurality of differences.

7. The method of claim 6, wherein the one or more intra prediction modes used in previously encoding the one or more data blocks of the source image comprise a plurality of intra prediction modes, and wherein determining the plurality of candidate intra prediction modes comprises identifying each of the plurality of intra prediction modes that is available for encoding the decoded data block as one of the plurality of candidate intra prediction modes.

8. The method of claim 7, wherein determining the plurality of differences comprises determining a plurality of sums of absolute difference between the decoded data block and predicted versions of the decoded data block as predicted using each of the plurality of candidate intra prediction modes, and wherein selecting one of the plurality of candidate intra prediction modes based on the plurality of differences comprises selecting one of the plurality of candidate intra prediction modes for which the sum of absolute difference is smallest.

9. The method of claim 1, wherein the decoder portion outputs decoded image data corresponding to the one or more data blocks of the source image, and wherein the decoded data block is one of a data block of the decoded image data, a data block of a down-scaled version of the decoded image data, and a data block of an up-scaled version of the decoded image data.

10. An apparatus comprising:
initial candidate mode determination logic operative to obtain information from a decoder portion of a video transcoder regarding one or more intra prediction modes used in previously encoding one or more data blocks of a source image; and
intra prediction mode selection control logic operatively coupled to the initial candidate mode determination logic and operative to select an intra prediction mode for encoding a decoded data block corresponding to the one or more data blocks of the source image based on the information obtained from the decoder portion regarding the one or more intra prediction modes used in previously encoding the one or more data blocks of the source image.

11. The apparatus of claim 10, wherein the information obtained from the decoder portion indicates a plurality of intra prediction modes that were used in previously encoding the one or more data blocks of the source image and that are available for encoding the decoded data block, and wherein the intra prediction mode selection control logic is operative to:
determine an initial best candidate intra prediction mode for encoding the decoded data block based on a plurality of differences between the decoded data block and predicted versions of the decoded data block as predicted using each of the plurality of intra prediction modes;
determine one or more additional candidate intra prediction modes for encoding the decoded data block based on the initial best candidate intra prediction mode; and
evaluate the initial best candidate intra prediction mode and the one or more additional candidate intra prediction modes to select the intra prediction mode for encoding the decoded data block.

12. The apparatus of claim 11, wherein the intra prediction mode selection control logic is operative to:
identify one or more intra prediction modes adjacent to the initial best candidate intra prediction mode in order to determine the one or more additional candidate intra prediction modes;
determine, for each respective one of the initial best candidate intra prediction mode and the one or more additional candidate intra prediction modes, a sum of absolute difference between the decoded data block and a predicted version of the decoded data block as predicted using the respective intra prediction mode; and
select, from the initial best candidate intra prediction mode and the one or more additional candidate intra prediction modes, the intra prediction mode for which the sum of absolute difference is smallest as the intra prediction mode for encoding the decoded data block.

13. The apparatus of claim 10, wherein the initial candidate mode determination logic is operative to determine a plurality of candidate intra prediction modes for encoding the decoded data block based on the information obtained from the decoder portion regarding the one or more intra prediction modes used in previously encoding the one or more data blocks of the source image, and
wherein the intra prediction mode selection control logic is operative to:
determine a plurality of differences between the decoded data block and predicted versions of the decoded data block as predicted using each of the plurality of candidate intra prediction modes; and
select one of the plurality of candidate intra prediction modes as the intra prediction mode for encoding the decoded data block based on the plurality of differences.

14. The apparatus of claim 13, wherein the intra prediction mode selection control logic is operative to:
determine a plurality of sums of absolute difference between the decoded data block and the predicted versions of the decoded data block as predicted using each of the plurality of candidate intra prediction modes in order to determine the plurality of differences; and
select one of the plurality of candidate intra prediction modes for which the sum of absolute difference is smallest as the intra prediction mode for encoding the decoded data block.

15. The apparatus of claim 10, comprising:
a display;
one or more processors operatively coupled to the display;
the decoder portion of the video transcoder, the decoder portion operative to obtain, from an image source, encoded source image data corresponding to the one or more data blocks of the source image and output decoded image data corresponding to the one or more data blocks of the source image;
encoding logic operatively coupled to the decoder portion and operative to:
obtain the decoded data block from the decoded image data; and
encode the decoded data block using the selected intra prediction mode to provide encoded output image data to the one or more processors; and
memory containing instructions that, when executed by the one or more processors, cause the one or more processors to decode the encoded output image data to provide output image data for display on the display.

16. The apparatus of claim 15, wherein the encoding logic is operative to obtain the decoded data block from the decoded image data as one of a data block of the decoded image data, a data block of a down-scaled version of the decoded image data, and a data block of an up-scaled version of the decoded image data,
wherein when the encoding logic obtains the decoded data block as a data block of the down-scaled version of the decoded image data, the apparatus comprises down-scaling logic operatively coupled to the decoder portion and to the encoder portion and operative to:
obtain the decoded image data output by the decoder portion; and
down-scale the decoded image data to output the down-scaled version of the decoded image data, and
wherein when the encoding logic obtains the decoded data block as a data block of the up-scaled version of the decoded image data, the apparatus comprises up-scaling logic operatively coupled to the decoder portion and to the encoder portion and operative to:
obtain the decoded image data output by the decoder portion; and
up-scale the decoded image data to output the up-scaled version of the decoded image data.

17. An apparatus comprising:
image data analysis logic operative to:
analyze image data corresponding to one or more data blocks of a source image to determine information regarding one or more intra prediction modes that were used in previously encoding the one or more data blocks of the source image; and
provide the information regarding the one or more intra prediction modes that were used in previously encoding the one or more data blocks of the source image to an encoder portion of a video transcoder for use by the encoder portion in selecting an intra prediction mode for encoding a decoded data block corresponding to the one or more data blocks of the source image.

18. The apparatus of claim 17, wherein the image data analysis logic is operative to parse header data within the image data corresponding to the one or more data blocks of the source image to determine the information regarding the one or more intra prediction modes that were used in previously encoding the one or more data blocks of the source image.

19. The apparatus of claim 17, comprising decoded image data prediction logic operatively coupled to the image data analysis logic, the image data analysis logic operative to provide decoded image data prediction information to the decoded image data prediction logic, the decoded image data prediction logic operative to:
determine a decoded image data prediction corresponding to the one or more data blocks of the source image based on the decoded image data prediction information; and
provide the decoded image data prediction for determination of the decoded data block.

20. The apparatus of claim 19, wherein the decoded image data prediction logic is operative to provide the decoded image data prediction for summation with a decoded residue corresponding to the one or more data blocks of the source image so as to determine decoded image data corresponding to the one or more data blocks of the source image,
wherein the decoded data block is one of a data block of the decoded image data, a data block of a down-scaled version of the decoded image data, and a data block of an up-scaled version of the decoded image data.
